(19) United States
(12) Patent Application Publication
(10) Pub. No.: US 2012/0272445 A1
(43) Pub. Date: Nov. 1, 2012

(54) WATER POWERED LIGHTING SYSTEM

(75) Inventors: Patrick Bruce Healy, Costa Mesa, CA (US); Frank Merten, Hermosa Beach, CA (US)

(73) Assignee: NUWHIRL SYSTEMS CORPORATION, Santa Ana, CA (US)

(21) Appl. No.: 13/456,203

(22) Filed: Apr. 25, 2012

Related U.S. Application Data
(60) Provisional application No. 61/478,854, filed on Apr. 25, 2011.

(51) Int. Cl. F21L 4/02; A47K 3/02

(52) U.S. Cl. 4/541.1; 362/185

(57) ABSTRACT

Water-powered lighting systems for use in connection with baths, spas and the like are disclosed. Some embodiments disclosed herein provide a water-powered lighting apparatus including a light fixture having a housing, wherein an electrical generator is disposed in the housing. The electrical generator may include a turbine wheel configured to be rotated by flowing water coming in contact therewith, such as water flowing in a water-jet piping system of a bath or spa. The electrical generator may provide energy used to power one or more light sources of the lighting system, thereby providing lighting to a target area. Certain embodiments disclosed herein may allow for lighting of a bath or spa without the need for electrical wiring, such as by using power provided by a water turbine generator.

### CROSS REFERENCE TO RELATED APPLICATIONS

This application claims the priority benefit under 35 U.S.C. §119(e) of U.S. Provisional Patent Application No. 61/478,854, filed Apr. 25, 2011, the entirety of which is hereby incorporated by reference herein.

### BACKGROUND

1. Field

This application relates to lighting fixtures and, in particular, to lighting fixtures used in bathtubs, spas and the like.

2. Description of Related Art

Whirlpool bathtubs, outdoor spas and the like often include jets that provide a flow of water into the bathtub or spa. Certain bathtubs and/or spas also incorporate lighting in some manner. However, prior systems have typically relied upon electric lighting, which causes risk in water environments.

### SUMMARY

This application describes certain water powered lighting systems that are useful in baths, spas and the like, and also baths, spas and the like incorporating such lighting systems.

### BRIEF DESCRIPTION OF THE DRAWINGS

FIG. 1 illustrates an exploded view of an embodiment of a water-powered lighting system.

FIG. 2 illustrates a cross-sectional view of an embodiment of a water-powered lighting system.

FIG. 3 provides a perspective view of an embodiment of components of a water-powered lighting system.

FIG. 4 illustrates a perspective view of an embodiment of components of a water-powered lighting system.

FIG. 5 illustrates an embodiment of an electrical generating device.

FIG. 6 depicts a perspective view of an embodiment of an assembled water-powered lighting fixture.

FIG. 7 illustrates an embodiment of a light source component of a water-powered lighting fixture.

FIG. 8 depicts an embodiment of a cap member of a water-powered lighting fixture.

### DETAILED DESCRIPTION OF PREFERRED EMBODIMENTS

Although certain preferred embodiments and examples are disclosed below, inventive subject matter extends beyond the specifically disclosed embodiments to other alternative embodiments and/or uses and to modifications and equivalents thereof. Thus, the scope of the claims that may arise here from is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Bathtubs and spas are often plumbed such that water flow may be directed through jets incorporated into the structure of the bathtub or spa into the bathing chamber. In addition, lighting integrated into bathtubs or spas has generally required lights powered by electrical wiring to plug into a power supply. A water-powered lighting system as described herein may alleviate some of the cost, installation complexities, and/or electrical danger often associated with bathtub or spa lighting systems. Indoor bathing has typically relied upon lighting from the building. Lighting in the bath can aid vision, reduce accidents and provide decorative effects. For example, the use of multiple LED lights can provide a variety of colors and/or lighting sequences.

In baths and spas, water propagating through a jetting pipe, or network of pipes, acts as a working fluid to power the lights described herein. As a working fluid, such water contains some amount of potential energy related to water pressure, and/or kinetic energy related to the propagation velocity of the water. In certain embodiments described herein, a turbine develops torque by reacting to the water pressure and/or flow.

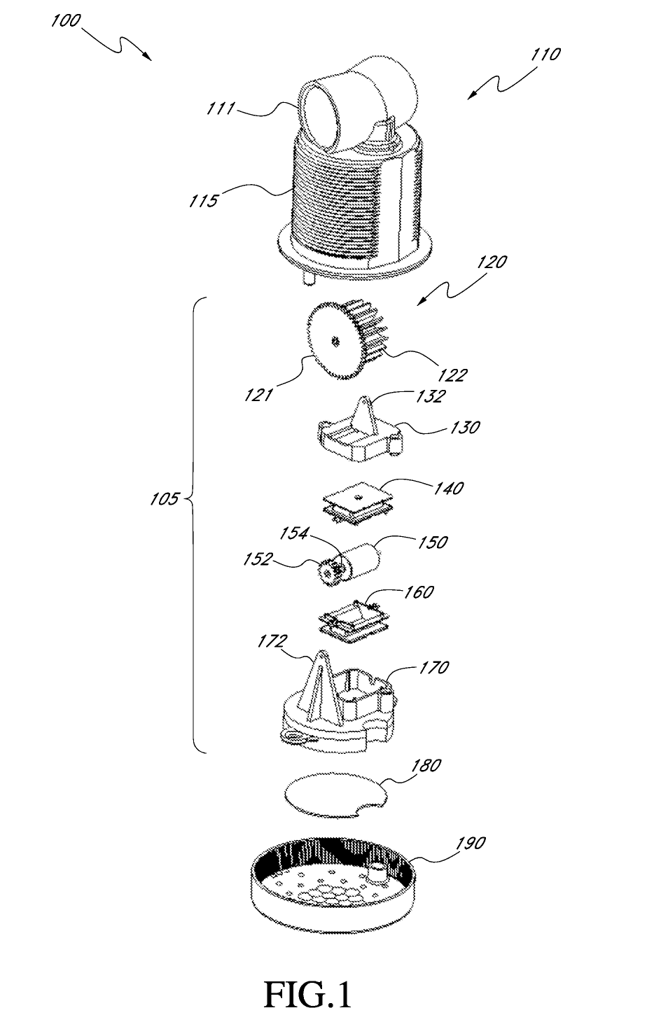

FIG. 1 illustrates an exploded view of an embodiment of a water-powered lighting system. The system includes a number of components that can be assembled for installation in a bathtub, spa, or other suitable structure or device, and may be configured to operate in connection with one or more water lines for one or more bathtub or spa jets. The embodiment of FIG. 1 may be conducive to simplified installation. For example, installation of a system configured in accordance with the embodiment of FIG. 1 may be capable of installation by drilling a hole in a bathtub or spa, typically in the wall or walls, attaching the assembled structure depicted in exploded view in FIG. 1, and plumbing one or more water lines for one or more jets. In certain embodiments, a bathtub or spa wall may be fitted with a hole in the 2-3 inch diameter range, such as, for example, a 2¾ inch diameter hole, for accommodating installation of a lighting fixture as described herein. Dimensions of various holes, fixtures, or other components may be determined based on aesthetic, functional, or other considerations. The water piping supplying water to the jets of whirlpool baths and spas typically runs outside the bath along or near the external walls. This provides a convenient way to mount and connect the water powered lighting systems herein to such piping and through the nearby wall of the bath.

Certain embodiments in accordance with FIG. 1 include a fixture enclosure 110 with a housing 115, which encloses an electrical turbine generator 105. Although the components of system 100 are depicted in various shapes and sizes, it should be understood that various components may be constructed in any suitable or desirable size or shape. For example, housing 115 may be have an oval or rectangular shape, depending on system requirements or preferences but is typically generally cylindrical. The fixture may have a flange 116 at one end to grip the inner wall of a bath or spa. The housing may have threads 117 for receiving a lock nut (not shown) to grip the outer side of the wall of the bath or spa, so as to hold the fixture in place. This arrangement makes it easy to access the entire unit without disturbing pipes or requiring a contractor. Such access can be important for cleaning or replacement of parts. The pressure and/or velocity of water flowing through the housing 115 is altered to some degree as it passes through turbine rotor blades 122, thereby causing the rotor to rotate about an axis which is, in certain embodiments, substantially perpendicular to the direction of fluid flow through the housing 115 of the fixture enclosure 110.

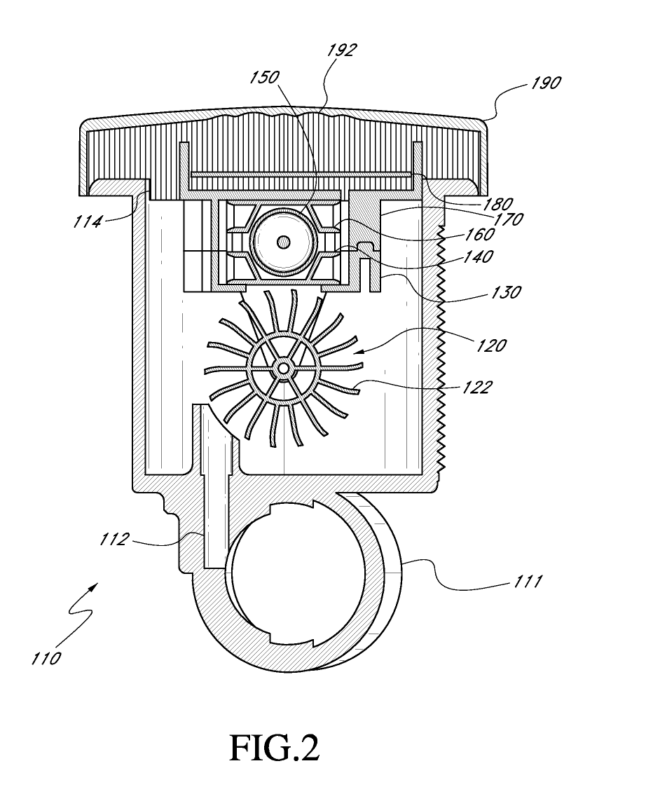

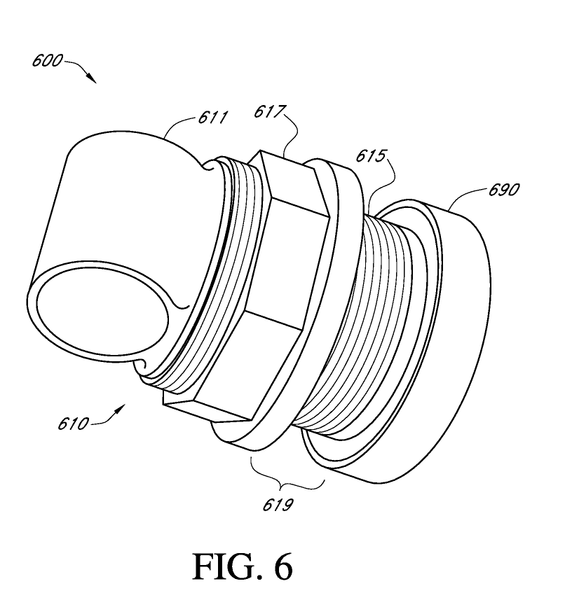

The enclosure 110 may contain and direct water flow as it acts on the turbine. Enclosure 110 is described in further detail below with respect to FIGS. 2 and 6. As water contacts rotor blades 122, it exerts pressure on the rotor blades 122, and the water is thereby decelerated. In this process, a portion of the water's momentum is transferred to the turbine 150. Various design specifications are contemplated in connection with the turbine system 105 embodied in FIG. 1 that achieve various degrees of efficiency and power generation. For example, the system 100 may be designed such that the velocity of water moving through the system is some multiple of the radial velocity of the rotor blades 122 moving in reaction to the water flow, such as twice the radial velocity of the rotor blades 122. Varying levels of efficiency and power generation may be achieved through adjustment to the length, thickness, weight, width, position or other characteristic of the rotor blades 122. Furthermore, the dimensions and characteristics of the various other components of the system 100 may affect the efficiency of the system 100. For example, component design that inhibits or encourages fluid flow through the system 100 may influence the transfer of energy from the fluid flow to the turbine 150, thereby affecting the efficiency of the system 100.

The embodiment depicted in FIG. 1 further illustrates a shaft 154, which may be a high-speed shaft, dependent on the relative diameter of gear 152 to that of turbine wheel 120. Gear 152 may serve to increase the rotational speed of the shaft 154 compared to the speed of rotation of turbine wheel 120. Gear 152 is fixed to shaft 154, such that rotation of the gear 152 produces corresponding rotation in shaft 154, which serves to drive the generator 150. Generator 150 may be any suitable mechanical-to-electrical energy converter that is capable of converting rotational energy produced by a working fluid exerting rotational force on turbine wheel 120 into electrical energy, such as an electromagnetic generator. Such generators typically use mechanical energy to force electrons in windings to flow through an external circuit, producing electrical energy thereby.

The system 100 includes a turbine wheel 120, which is exposed to water flowing through the system 100. As discussed above, flowing water contacts the rotor blades 122 of the turbine wheel 120, exerting rotational force on the turbine wheel 120. The turbine wheel 120 and/or rotary gear 152 and shaft 154 constitute the rotor assembly portion of the electrical turbine 150. Turbine wheel 120 includes a gear region 121 and a blade region 122. The blade region 122 is fixed to the gear region 120, such that rotational force exerted on the blade region 122 exerts a corresponding rotational force on the gear region 120. The blade region 122 includes one or more blades. In certain embodiments, blades 122 extend radially outward from the axis of rotation of the turbine wheel. The blades 122 may be shaped or curved in a manner that facilitates the transfer of energy from flowing water to the turbine wheel 120. For example, the blades 122 may be curved such that a concave surface of a blade primarily opposes the direction of fluid flow when the blade is being acted upon by flowing water. In certain embodiments, the blades are substantially straight, or portions of the blades 122 are substantially straight. The turbine wheel 120 is in physical connection with a shaft (not shown). The shaft may be a component of the turbine wheel 120, or may be fixed to a stator portion of the turbine 105. The shaft allows for rotation of the turbine wheel 120 while the stator portion (e.g., 130, 170) remains stationary. The turbine wheel 120 and/or shaft may be physically secured to the stator portion at a point adjacent to the gear portion 121, the blade portion 122, or both In the embodiment depicted in FIG. 1, the turbine wheel 120 is secured to two distinct components of the stator portion of turbine 105, specifically, components 132 and 172. The turbine wheel 120 is described in further detail below with regard to FIG. 2.

The turbine 105 includes an upper stator member 130. Upper stator member may be secured to lower stator member 170. In the embodiment depicted in FIG. 1, each of upper stator member 130 and lower stator member 170 includes a rotor connection member 132, 172, which extends upwardly with respect to the orientation of FIG. 1 and connects to the turbine wheel 120, or to a shaft connected to turbine wheel 120, such that the turbine wheel 120 is permitted to rotate freely, or with minimal resistance, while the stator members 130, 170 remain stationary. In the embodiment of FIG. 1, the stator members 130, 170 serve as a housing for generator 150, upper and lower generator housing members 140, 160, each of which are discussed below, as well as possibly other components of the system 100.

The system 100 includes a generator 150, which may be contained within a protective casing, preferably made of a rigid material, such as plastic. In the embodiment depicted in FIG. 1, the generator 150 is positionable within a housing comprising two separable components, an upper housing member 140 and a lower housing member 160. In an assembled state, the generator 150 is nestingly positioned within the two housing members 140, 160. In certain embodiments, the housing members 140, 160 secure the generator 150 via physical contact with rotary shaft 154, while still allowing rotation of the shaft 154 during operation of the system 100. In an assembled state, the housing 140, 160 may provide one or more inlet channels in which the shaft 154 lies, thereby allowing one or more distal portions of the shaft 154, such as the portion of shaft 154 located adjacent to gear 152, to be exposed to the exterior of the housing. Such a configuration allows the shaft 152, via gear 152, to be in mechanical communication with turbine wheel 120, and, indirectly, fluid flowing through the system 100.

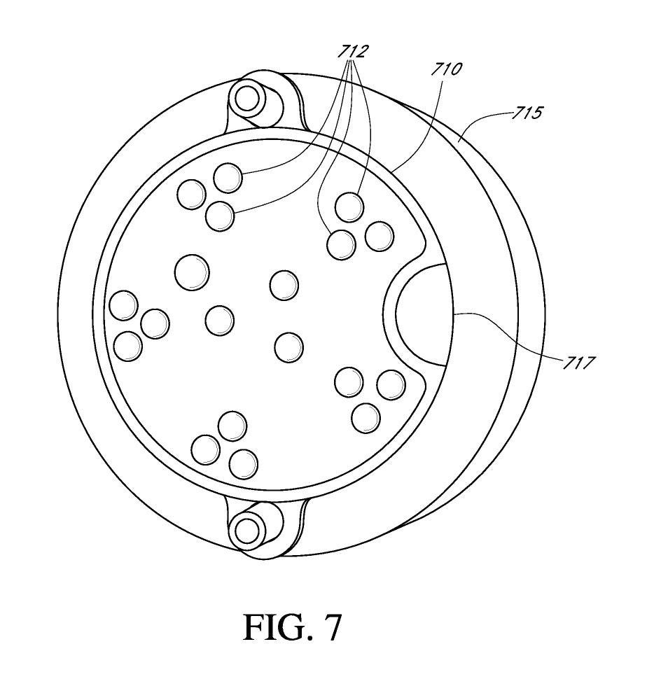

Generator 150 is in electrical communication with one or more light sources, such as, for example, light-emitting diodes (“LED's”). In the embodiment depicted in FIG. 1, one or more light sources (not shown) are mounted or connected to a circuit board 180, which may be mounted to or integrally formed with one or more structural components of system 100. References herein to an illumination plate, or plate to which one or more light sources is either directly or indirectly mounted, should be understood broadly to refer to a circuit board electrically connected to the one or more light sources, or to one or more components physically connected to, or positioned adjacent to such circuit board, or any combination of such structures or components. Illumination plate 180 may be secured in some way to lower stator member 170, and may be positioned between lower stator member 170 and an outer cap member 190, discussed below. FIG. 7, described below, provides further detail with regard to illumination plate 180.

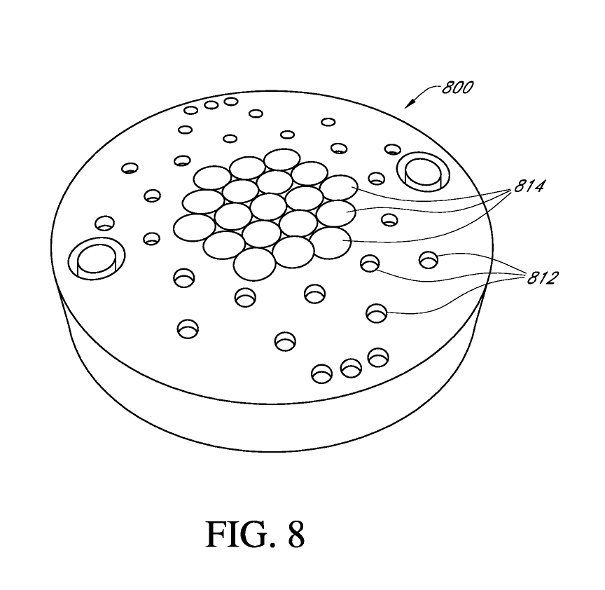

The illustrated embodiment of system 100 includes a cap member or lens 190, which connects to enclosure 110. Water flowing through the enclosure 110, and among various components contained therein, is permitted to exit the enclosure through apertures located in cap member or lens 190. As assembled, the various turbine components 105 are contained within the enclosure 110, while the cap member or lens 190 is externally exposed, for example, to the inside of a bath or spa. In certain embodiments, the system 100 is positioned within the wall of a bath or spa such that only the external face of cap member or lens 190 is physically exposed to a user. In certain embodiments, the cap member 190 is substantially transparent, thereby allowing light transmitted from within the enclosure to exit the fixture. Cap member or lens 190 is discussed in further detail below with regard to FIG. 8.

FIG. 2 illustrates a cross-sectional view of an embodiment of a water-powered lighting system. The water-powered lighting apparatus shown in FIG. 2 is an embodiment of an assembled water-powered lighting system similar to that shown in FIG. 1. Many components like those illustrated in FIG. 1 are represented in FIG. 2. For convenience, components illustrated in FIG. 2 share reference numbers with similar components of system 100 in FIG. 1. However, such components, though numbered identically, may differ in material respects, as illustrated in FIG. 2. FIG. 2 includes an enclosure 110 with two main regions, a main water flow channel 111, and a jet channel 118. In the embodiment of FIG. 2, the jet channel directs water tangentially or perpendicularly relative to the main water channel 111. An intermediate channel 112 directs water from the main channel 111 into the jet channel 118. The intermediate channel 112 may have any suitable shape or size. For example, the intermediate channel 112 may have a circular, oval-shaped, rectangular, or other cross-section. Channel 112 terminates in an orifice that forms an inlet to an internal chamber that houses a turbine. The orifice can have the same or similar cross section to the channel 112. Non circular, such as an oval or rectangular-shaped orifice may be incorporated to increase energy transfer between the working fluid and the turbine wheel by distributing water more evenly over the surface of the blades 122. For similar energy conservation reasons, the orifice/inlet can be positioned close to the outer circumference of wheel 120 and aimed tangentially thereto. For that positioning, the orifice or inlet may be cut away at an angle that generally follows the outer circumference of wheel 120. In certain embodiments, the width or diameter of such a channel is less than ½ inch, such as, for example, ⅜ of an inch. In any event, it may be desirable for the intermediate channel 112 to have a diameter or width of 3/16 of an inch or greater, such as within the range of 3/16 to ½ inch, to help prevent clogging. Water directed through the intermediate channel 112 and into the jet channel is directed past the turbine wheel 120, thereby effecting a rotation in the turbine wheel 120. Water is directed from the inlet intermediate channel 112 towards outlet channel 114, and is ultimately jettisoned through apertures (see FIG. 8) in cap member 190.

The blades 122 depicted in FIG. 2 are curved at their distal end. As discussed above, such curvature may aid in the transmission of energy between fluid flowing within the jet channel 118 and the turbine wheel 120. In certain embodiments, the blades 122 are configured to facilitate power generation in the presence of relatively low water pressure. Water propagating through water lines often has lower water pressure than other water lines, such as a shower head line, and therefore it may be desirable for a system in accordance with embodiments described herein to be configured to accommodate relatively low water pressure. For example, water pressure may be in the range of 5-10 or 5-15 psi from the pump, or may be as high as 20 psi or more at various points in the system. In addition, such a system may experience some decrease in water pressure from the pressure source pump to the system outlet, such as a drop-off of approximately 1 psi. Water pressure values may be dependent on factors such as the size or type of pump used, the number of jets installed, and/or the piping configuration. It may be desirable to configure a system such that approximately 8 psi is achieved at the pump outlet. In certain embodiments, water pressure in the fixture may be as low as 2 psi, or lower. In contrast, a shower head may provide water pressure of up to 80-100 psi, or greater. In certain embodiments, the turbine wheel 120 may comprise blades 122 with relatively large surface area, or length. The turbine wheel 120 may be constructed with a diameter of approximately 1-1½ inches, or any other suitable diameter. For example, the turbine wheel 120 may have a diameter of approximately 1⅜ inches. In addition, with of the turbine wheel may be around ⅞ of an inch, or any other suitable width.

Desirable water flow rates for the water-powered lighting systems described here in may be of 3-10 gallons-per-minute (GPM). For example, a water flow rate from 4 to 8 GPM may be preferable. The fixture thereby uses relatively little water.

Electricity generated by generator 150 is provided to one or more light sources (not shown) positioned on illumination plate 180, thereby powering the light sources. Light from the illumination plate 180 is transmitted through cap member 190, which is at least partially transparent. Cap member 190 may include one or more optical lenses 192 for light transmission or diffraction. The embodiment depicted in FIG. 2 includes a plurality of negative-meniscus convex lenses 192.

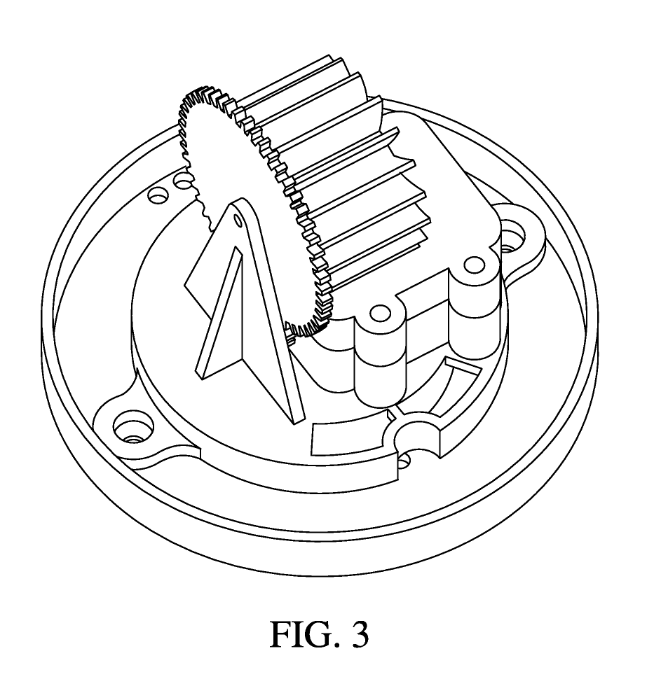

FIG. 3 provides a perspective view of an embodiment of components of a water-powered lighting system. As shown in the figure, the lower stator member 370 is positioned adjacent to the back surface of cap member 390. In an assembled state, cap member 390 is connected to an enclosure portion (not shown), such that the other depicted components are contained within the enclosure.

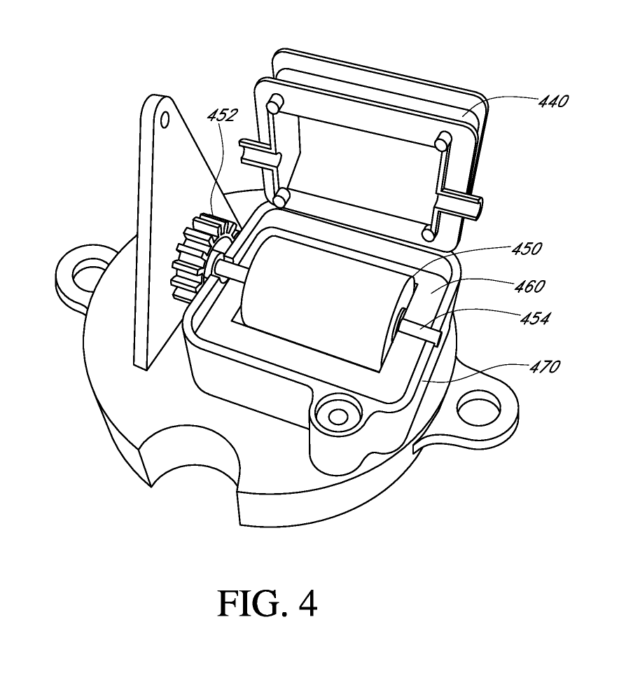

FIG. 4 illustrates a perspective view of an embodiment of components of a water-powered lighting system. In the embodiment depicted in FIG. 4, a lower generator housing member 460 is nestingly disposed within a receiving portion of a lower stator member 470. The lower housing member 460, in combination with upper housing member 440, which is depicted in an open position, houses the generator 450. In an assembled state, upper housing member is placed in a closed position, such that it lies substantially on top of lower housing member, thereby housing the generator 450, as well as a portion of generator shaft 454. As illustrated, a gear 452 is fixed to generator shaft 454 such that rotation of the gear 452 results in corresponding rotation of the shaft 454. Such rotation may be necessary for electrical energy generation.

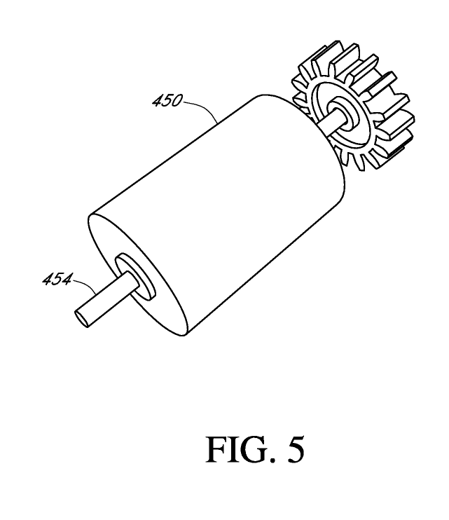

Electrical generator 450 is disclosed as removed from the housing in FIG. 5. As illustrated in FIG. 5, generator portion 450 may be cylindrical, and surround the generator shaft 454. The shaft is positioned along a central axis of the cylindrical generator portion 450. Rotation of the generator shaft causes electrical energy to be generated that provides power for one or more light sources. Electrical generator 450 requires no independent source of electrical power. Such power independence can provide the benefit of reduced system complexity, which may be particularly desirable in the context of lighting fixtures used in whirlpool bathtubs and outdoor spas and the like, as it is often inconvenient and potentially hazardous to provide electrical wiring from an outside power source in connection with such devices. Batteries likewise may be undesirable in such devices, as they require periodic replacement and are often somewhat bulky. In addition, as it is often desirable to utilize lighting in a bathtub or spa when jets are activated, a lighting fixture that is powered by the jets' water stream provides functionality at precisely such times. For example, a lighting unit in accordance with one or more embodiments described herein may operate whenever the jet system is operating, and may shut off in connection with an associated water pump shutting off. Furthermore, installation of a system in accordance with embodiments disclosed herein may be less complex due to the lack of need to effect electrical connections to sources that would otherwise be required for operation of the fixture.

In certain embodiments, generator 450 provides a direct-current (DC) output to power one or more light sources. System power requirements with respect to power output of generator 450 may vary depending on the specifications of the system. For example, in an embodiment in which power from the generator 450 us used to power 18 LED's, 5-volt DC output may be desirable, or approximately 100 mA. Systems with fewer or more light sources to power may require varying amounts of power output from a generator.

FIG. 6 depicts a perspective view of an embodiment of an assembled water-powered lighting fixture for mounting to a bathtub or spa, or any other desirable structure or device. The fixture 600 includes a main water channel 611, which is configured to be coupled to a water distribution system. In certain embodiments, the main water channel 611 is a tubular or pipe-like channel with more than one opening, configured such that water from a water circulation system is permitted to enter the main channel 611 through one opening and exit through another. In certain embodiments, the main water channel 611 provides a substantially straight, or slightly curved, water path, which may promote unobstructed fluid flow. In certain embodiments, at least a portion of water flow flowing through the main channel 611 is diverted into an enclosure channel 615, which may direct water flow in a direction substantially perpendicular to the flow of water through the main water channel 611. Channel 611 may be formed by a tubular fitting 612 of the type that can be cemented to standard plastic pipe.

The lighting fixture 611 may be configured to be mountable to a wall or other component of a bathtub or spa, or any other suitable structure or device. To such end, the fixture may be equipped with a fastener member 617 for securing the fixture to a structure or device, such as the wall of a bathtub or spa. In the embodiment depicted in FIG. 6, the outside wall of the enclosure channel 615 is fitted with a thread-type structure for winding the fastener member 617 along the length of the enclosure channel 615. However, any suitable means of fastening the lighting fixture 600 to a structure or device may be implemented, if feasible. For example, the fixture may be attached to a structure or device by a bolt or some kind of adhesive. Implementation of a system in accordance with the embodiment of FIG. 6, which depicts a hardware fastener with a threaded hole, may provide the benefit of reduced complexity, reduced cost, desirable water-sealing capability, and/or ease of installation. In certain embodiments, the fastening member 617 is adjusted such that the distal portion 690 of the fixture 600 and the fastening member apply compression pressure to a wall or other structural component of a bathtub or spa, thereby securing the fixture 600 to the bathtub or spa. Therefore, for example, a portion of a wall of a bathtub or spa may be sandwiched between the distal portion 690 and the fastening member 617 adjacent to region 619 of the outside of the enclosure channel 615. For example, the fixture may accommodate varying wall thicknesses on region 619 of up to 2 inches.

The distal portion 690 may be a cap or lens that is removable from the lighting fixture. Removal of the distal portion 690 may provide physical access to components of the fixture contained within the enclosure channel 615, such as to an electricity-generating turbine or its components, or to one or more light sources.

The lighting fixture 600 may be made of any suitable material. In certain embodiments, the fixture 600 comprises a number of different materials. For example, the removable distal portion 690 may be made of a different material from the fastening member, main water channel and/or the elongate channel 615. Preferably, the components illustrated in FIG. 6 comprise materials that are rigid and possibly light weight, such as plastic. It may be desirable for the fixture to be made of materials that are resistant to water damage, as certain components may be exposed to varying amounts of water or moisture.

FIG. 7 illustrates an embodiment of a light source component of a water-powered lighting fixture. The light source component includes one or more light sources. In the embodiment depicted in FIG. 7, the light source component 710 includes a plurality of LED's 712. Typically, the LED's may be arranged in groups of three. One being red, the second blue and the third green. With suitable programming, they may be illuminated separately, or in various combinations as well as for varying times and sequences to provide decorative effects. When such a group of three are illuminated together, white light can be produced. The light source component 710 may be attachable or securable in some manner to the body 715 of a lighting fixture. For example, as depicted in FIG. 7, light source component 710 may include one or more ring-like male connecting structures that can be placed over corresponding projection-like female structures of the lighting fixture body 715. The LED's 712 are electrically connected to a source of electrical power, such as a turbine generator, the components (not shown) of which may be located underneath the lighting component 710. The illustrated fixture includes an opening 717 located between the lighting component 710 and the lighting fixture body 715. Opening 717 permits the passage of water from within the lighting fixture body so that it may be jettisoned from the fixture. Water exiting the fixture through opening 717 may be ultimately introduced into the basin of a bathtub or spa. While light source component 710 may incorporate any feasible type of light source, the use of LED's may be desirable based on cost, size, maintenance, and/or electricity consumption concerns or requirements. Furthermore, the light source component 710 may allow for constant single-color lighting, changing-color light patterns, or any other configuration.

FIG. 8 depicts an embodiment of a cap portion of a water-powered lighting fixture. In certain embodiments, the cap portion may be securable to the distal end of a lighting fixture. Such securing may be accomplished by screwing, threading, bolting, or otherwise fastening the cap or lens 800 to the fixture. In certain embodiments, the cap member has a diameter of approximately 3-4 inches, such as, for example, a 3½ inch diameter. While the depicted cap 800 has a circular face, any suitable or desirable shape may be utilized. For example, cap 800 may be oval or rectangular in shape, based on system specifications, aesthetic or design considerations, or other considerations.

In certain embodiments, the cap member 800 is transparent, or at least partially transparent, allowing light from a light source positioned beneath the cap 800 to be transmitted through the cap 800 into the surrounding environment. In certain embodiments, the cap 800 includes one or more apertures 812, through water may flow. The cap thereby accommodates implementation of the lighting fixture as a jet, or part of a jet, in a bathtub or spa. The cap 800 may include any number of apertures, and such apertures may be any desirable size. In certain embodiments, the apertures 812 are relatively small compared to the cap 800 itself, and may be somewhat spaced apart and spread over the surface of the cap 800.

Cap portion 800 may also include one or more lenses for altering the transmission of light through the cap 800. The depicted embodiment in FIG. 8 includes a number of relatively small lenses centrally located on the face of the cap portion 800. Lenses associated with the cap portion 800 may be of any desirable curvature or configuration. For example, lenses 814 may have a positive or negative meniscus, may be convex and/or concave, and may cause convergence or divergence of light passing therethrough. In certain embodiments, the entire face of the cap portion 800 acts as a lens. Lenses may be desirable in connection with lighting fixtures according to embodiments disclosed herein as providing enhanced aesthetic appeal. Furthermore, lenses may allow for greater range of illumination with respect to light sources incorporated in a water-powered lighting fixture.

In certain embodiments, the cap or lens portion 800 is removable from the remainder of the lighting fixture. Removability of the cap portion 800 may provide greater ease of cleaning, replacement, or adjustment of the fixture or any of its component parts. For example, a light source component may be removable and replaceable from the inside of the bathtub or spa. Replacement of a light source may be necessary following failure of the light source, or other problem associated with the light source. As bathtub or spa lighting fixtures are often exposed to high levels of moisture and humidity, such environments may be conducive to mold and/or bacteria growth, and therefore ease of cleaning may be desirable. In addition, components in frequent contact with water may be susceptible to the buildup of water-related deposits, such as soap scum or other deposits. As a result, periodic cleaning may be desired to maintain aesthetic appeal, or avoid corrosion or other damage.

Reference throughout this specification to “certain embodiments” or “an embodiment” means that a particular feature, structure or characteristic described in connection with the embodiment is included in at least some embodiments. Thus, appearances of the phrases “in certain embodiments” or “in an embodiment” in various places throughout this specification are not necessarily all referring to the same embodiment and may refer to one or more of the same or different embodiments. Furthermore, the particular features, structures or characteristics can be combined in any suitable manner, as would be apparent to one of ordinary skill in the art from this disclosure, in one or more embodiments.

As used in this application, the terms “comprising,” “including,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Similarly, it should be appreciated that in the above description of embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that any claim require more features than are expressly recited in that claim. Rather, inventive aspects lie in a combination of fewer than all features of any single foregoing disclosed embodiment.

What is claimed is:

1. A bathing apparatus comprising:
a pump;
a tub having walls, at least one device for supplying water thereto and at least one water outlet;
at least one jet mounted in at least one of said walls;
at least one water pipe, extending from said pump to said jet or jets; and
at least one light fixture, mounted in at least one of said walls and fluidly connected to said water pipe or pipes;
said light fixture comprising:
a housing having walls forming an inner chamber;
an electrical generator in said chamber, electrically connected to a plurality of light emitting diodes;
said generator comprising a turbine wheel configured to cause upon rotation the production of electricity by said generator;
said housing further comprising a inlet configured to direct water from said pipe or pipes at said wheel to rotate said wheel;
and an element facing into the tub and made of a material permitting light from the light emitting diodes to project into the tub; and
an outlet from said chamber into said tub, so that, in use, water can be recirculated via the outlet of the tub through said pipe or pipes, said jet or jets and said light fixture.

2. The bathing apparatus of claim 1, wherein said element has one or more holes therethrough to permit water to exit the chamber.

3. The bathing apparatus of claim 1, wherein said element is removable to permit cleaning of said chamber.

4. The bathing apparatus of claim 1, wherein said pump is configured to produce a water pressure of from 5 to 15 psi.

5. The bathing apparatus of claim 1, wherein the flow rate of water through said fixture is from 3 to 10 gallons per minute.

6. A light fixture for a bathing apparatus, said light fixture comprising:
a housing having walls forming an inner chamber;
an electrical generator in said chamber, electrically connected to a plurality of light emitting diodes;
said generator comprising a turbine wheel configured to cause upon rotation the production of electricity by said generator;
said housing further comprising a inlet configured to direct water from said pipe or pipes at said wheel to rotate said wheel;
an element made of a material permitting light from the light emitting diodes to project therethrough;
said walls having an outer surface formed at least in part with threads; and
a threaded fastening member, movable along the threads to clamp said fixture to said wall of a bathing apparatus.

7. The light fixture of claim 6, further comprising a rear end and a front end and said front end of said housing having a flange for engaging the inner surface of a wall of a bathing apparatus.

8. The light fixture of claim 6, wherein said element has one or more holes therethrough to permit water to exit the chamber.

9. The light fixture of claim 6, wherein said element is removable to permit cleaning of said chamber.

10. The light fixture of claim 6, wherein said housing has a rear wall and an open front end, said inlet being formed in said rear wall and comprising a conduit therethrough terminating in a orifice to provide water flow in a direction generally tangential to the wheel, said element being attachable to said open end of the housing.

11. The light fixture of claim 6, further comprising a longitudinal axis extending from a rear end and a front end and defining a general direction of flow of water through the light fixture in use, said light fixture further comprising a pipe fitting to the rear of said rear wall extending in a direction generally transverse to said axis and for connection to a water supply pipe.

12. The light fixture of claim 6, wherein said chamber, inlet and/or generator are configured to properly light said light emitting diodes at a flow rate of water through said light fixture of from 3 to 10 gallons per minute.
